(19) United States
(12) Patent Application Publication
(10) Pub. No.: US 2005/0209890 A1
(43) Pub. Date: Sep. 22, 2005

(54) Method and apparatus creating, integrating, and using a patient medical history

(76) Inventor: Francis K. Kong, San Francisco, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/084,498

(22) Filed: Mar. 17, 2005

Related U.S. Application Data
(60) Provisional application No. 60/554,126, filed on Mar. 17, 2004.

(51) Int. Cl. G06F 17/60

(52) U.S. Cl. 705/3; 706/8; 705/14

(57) ABSTRACT

This invention aids a physician and patient during a visit to an office or emergency room by providing the physician with a previously prepared medical history of the patient, which may further preferably include a list of advertisements for medical products compatible with the medical history. The previously prepared medical history is a product of an interview process having significant potential as a statistical indicator of epidemics and early warning indicator of the impact of weapons of bio-terrorism.

### CROSS REFERENCE TO RELATED PENDING APPLICATIONS

This application claims the benefit of provisional patent application Ser. No. 60/554,126 filed Mar. 17, 2004, which is incorporated herein by reference.

### TECHNICAL FIELD

This invention pertains to aiding a physician and patient during a visit to an office visit or emergency room. The invention further pertains to providing the physician with a previously prepared medical history of the patient, which may further preferably include a list of advertisements for medical products compatible with the medical history. The previously prepared medical history is a product of an interview having significant potential as a statistical indicator of epidemics.

### BACKGROUND OF THE INVENTION

The typical physician office visit consists of three parts: (1) patient history gathering, (2) diagnosis, and (3) treatment. In an average physician office visit, all three parts must be completed under significant time pressure, typically 15 minutes or less. However, the less time that a physician has to complete the history gathering and the other parts of the visit, all else equal, the greater the likelihood of medical errors, material omissions and malpractice lawsuits resulting from the visit.

In a typical physician office visit, the physician proceeds to gather the medical history of the patient, only after the patient has arrived at the office. It is not uncommon for the history-gathering phase to take up more than half of the allotted time. Still, physicians often cannot be sure that in the short period of time allotted for each patient that he has gathered sufficient and relevant medical information.

Second, in addition to time pressure in gathering a patient's history, the volume of medical studies, treatments, possible tests, and pharmaceutical product information that physicians must memorize and understand continues to increase. Already under time pressure, a physician often does not have time to read and understand medical studies and product information from pharmaceutical companies. Not surprisingly, pharmaceutical companies are expending considerable resources to deliver product information under less than ideal conditions, e.g., during a physician's lunch or on his way to another appointment.

Therefore, not only is a physician often gathering patient histories under significant time pressure, but the problem is compounded with diagnosing and prescribing medication to patients under significant time pressure as well. Generally, in diagnosis and treatment, the physician is limited to what he can recall from memory, or by way of a quick reference at the most.

There is a need for a system of methods and processes that effectively extend the physician office visit through modifying the patient history taking process, and aids the physician in diagnosing and treating the patient.

Not only are the lack of time and information a problem for the typical office visit, but they are also a problem emergency room visits. In the case of an emergency visit, the tasks of patient history gathering are even more complicated, because the patient is sometimes unconscious and under greater duress, and cannot provide his medical history and correct medications.

Also, current methods for a patient to manage his own medical history are cumbersome. Medical records are often kept on paper or proprietary systems, and at the physician's offices or medical facilities. The form/structure is generally not uniform from physician to physician. Also many times, physician's notes are hand written and difficult to read. Many patients have a very difficult time transferring medical records to a new physician or medical group after he has moved, changed insurance carriers, employers or health care providers.

Therefore, in addition, to the need for methods and systems to extend the physician office visit and aid the physician, there is a need for a centralized medical data system. A centralized system to maintain patient histories and histories of diagnosis and treatment would not only serve the methods and processes for a non-emergency visit, but also address some of the difficulties in emergency medicine and the management of patient data.

### SUMMARY OF THE INVENTION

This invention aids a physician and patient during a visit to an office or emergency room by providing the physician with a previously prepared medical history of the patient.

The previously prepared version of the medical is based upon an interview process. The interview process starts by asking a list of general questions about the patient's health. Each of the patient's answers is translated into standard medical terms to create a symptom report.
The interview process may further ask at least one follow-on question based upon the patient's answers. The patient's answer to the follow-on question is used to refine the symptom report.
The symptom report does not attempt to diagnose the patient's health condition, but instead seeks to put the patient's symptoms into standard medical terms.
The symptom report expedites the use of the physician's time and maximizes the time that can be spent on treatment and/or education of the patient.
The symptom report is a product of the interview process, and has significant potential as a statistical indicator of epidemics and may further provide a significant early detection of the use of weapons of bio-terrorism.

The interview process may preferably be implemented as an inferential engine including a list of rules and a list of decision trees. The inferential engine may be preferably implemented by at least one computer executing a program system residing as program steps in a memory accessed by the computer. Alternatively, the inferential engine may be implemented using finite state machines, and/or Field Programmable Gate Arrays (FPGAs).
Each rule contains a symptom matching template and a fuzzy fact. By way of example, the symptom-matching template may trigger the fuzzy fact, that the patient may have the symptoms of one of the following: a cardiac event, or food poisoning, radiation illness, or an aneurysm.
The list of decision trees includes at least one decision tree, each of which starts from a central node. By way of example, the central node may involve the patient's sex, patient's ethnicity, and/or age group, and/or drug history, and/or disease history.
Each decision tree may further include a list of decisions. Each decision is based upon a statement of fuzzy facts, and includes at least one directive.
The statement of the fuzzy facts may include elements of the symptom report, such as the patient's sex, ethnicity, age group, drug history, and/or disease history. The statement of the fuzzy facts may also include statistical analyses of the incidence of the fuzzy facts over a period of time and/or within the locality.
The directive may include, but is not limited to, a question to be asked of the patient, a query to a medical database, a message reporting unusual incidences of the statement of fuzzy facts.
The inferential engine may further preferably adapt to the results of the visits to the office and/or emergency room to alter the list of rules and/or alter the list of decision trees.

The previously prepared medical history may further preferably include a list of relevant advertisements for medical products and/or services compatible with the medical history, as a product of a process preparing the medical history based upon the symptom report and a list including advertising elements.
Each advertising element includes an advertisement and a symptom-matching template.
The symptom-matching template is compared to the symptom report.
The advertising elements, which have symptom matching templates compatible with the symptom report, contribute their advertisements as the list of relevant advertisements to be included in the previously prepared medical history.
The inferential engine may also preferably adapt to the symptom-matching templates of the advertisements.

The invention includes a method of doing business with medical advertisers, which generates the relevant advertisements.
The relevant advertisements target the physician with products and services relevant to the patient's symptoms and history.
The business method generates revenue from this targeted advertising for a medical history provider.
The revenue of the medical history provider may preferably provide a second revenue to a medical service provider to maintain, distribute and provide the interview process and mechanism, as well as the medical history generation method and mechanism.

The medical service provider may be any of a physician, a clinic, a public health facility, a hospital, a nursing home, a Health Maintenance Organization (HMO), and a rehabilitation center.
The medical service provider may preferably operate at least one computer executing a program system implementing the interview method and/or the preparation of the medical history.
The medical history provider may include a provider of the program system and/or a provider of the list of relevant advertisements and/or a provider of the list of medical advertisements used to select the list of relevant advertisements.

The medical advertiser may include distributors, marketing channels, sale representatives, and/or manufacturers of any of the following: pharmaceuticals, medical supplies, medical devices, herbs, and special services.
By way of example, special services may include, but are not limited, to physical therapy, acupuncture, mid-wives, shiatsu, massage, psychiatrists, and psychological counseling.
Medical devices may include, but are not limited to, pace makers, grafting media, wheel chairs, blood substitutes, hearing aids, and optical enhancements.

The business method includes the following steps:
The medical advertiser presents an advertisement and a symptom matching template to a medical service provider.
An advertising hit price is established between the medical advertiser and the medical service provider to create an agreement.
The agreement includes a commitment by the medical service provider to include the advertisement in the list of advertisements, as well as, to include the advertisement in the list of relevant advertisements when the symptom list is compatible with the medical history of a patient.
When the advertisement is included in the list of relevant advertisements, a revenue report is altered to include the advertising hit price. The medical advertiser receives the revenue report and creates the revenue received by the medical service provider.
The agreement, the list of advertisements, the list of relevant advertisements, the revenue report, and the revenue are products of this business method.

### BRIEF DESCRIPTION OF THE DRAWINGS

Embodiments of the Universal Medical Matrix invention are illustrated by way of example, and not by way of limitation, in the figures of the accompanying drawings and in which like reference numerals refer to similar elements:

FIG. 1 shows the medical history preparation module, including the medical history, the interview process, the inferential engine, the list of advertising elements, the office, the emergency room, the previously prepared medical history, the medical advertiser, the medical history provider, the revenue based upon the agreement, and the second revenue to the medical service provider;

FIG. 2A shows some details of the advertising element of FIG. 1;

FIG. 2B shows the list of rules of FIG. 1;

FIG. 2C shows the list of decision trees of FIG. 1;

FIG. 3B shows a data centralization system communicating with the medical history preparation module, the office and the emergency room of FIG. 1;

FIG. 3B shows some details of the belonging of the patient of FIG. 3A;

FIG. 4 shows an alternative view of the medical history preparation module of FIG. 1;

FIG. 5 shows the medical history preparation module of FIGS. 1 and 4 including a first computer;

FIG. 6 shows some details of the program system of FIG. 5;

FIG. 7A shows a means for interviewing of FIG. 4 including a second computer;

FIG. 7B shows a means for preparing the medical history of FIG. 4 including a third computer;

FIG. 8A shows the means for doing business of FIG. 4 including a fourth computer;

FIG. 8B shows the data centralization system including a fifth computer;

FIG. 9 shows further details of the medical history preparation module;

FIG. 10A shows some details of the medical service provider of FIG. 1;

FIG. 10B shows some details of the medical advertiser of FIG. 1;

FIG. 10C shows some details of a computer as used herein;

FIGS. 11A, and 12 to 14A show some details of the interview program system;

FIGS. 11B, 14B and 14C shows some details of the medical history preparation program system;

FIGS. 15A and 15B show some details of the business program system;

FIGS. 16A and 16B show some details of the emergency room secure access process;

FIGS. 17A and 17B show some details of the office access process;

FIG. 18A shows some details of the emergency room secure access program system; and

FIG. 18B shows some details of the office access program system.

### DETAILED DESCRIPTION

This invention pertains to aiding a physician and patient during a visit to an office visit or emergency room. The invention further pertains to providing the physician with a previously prepared medical history of the patient, which may further preferably include a list of advertisements for medical products compatible with the medical history. The previously prepared medical history is a product of an interview process having significant potential as a statistical indicator of epidemics.

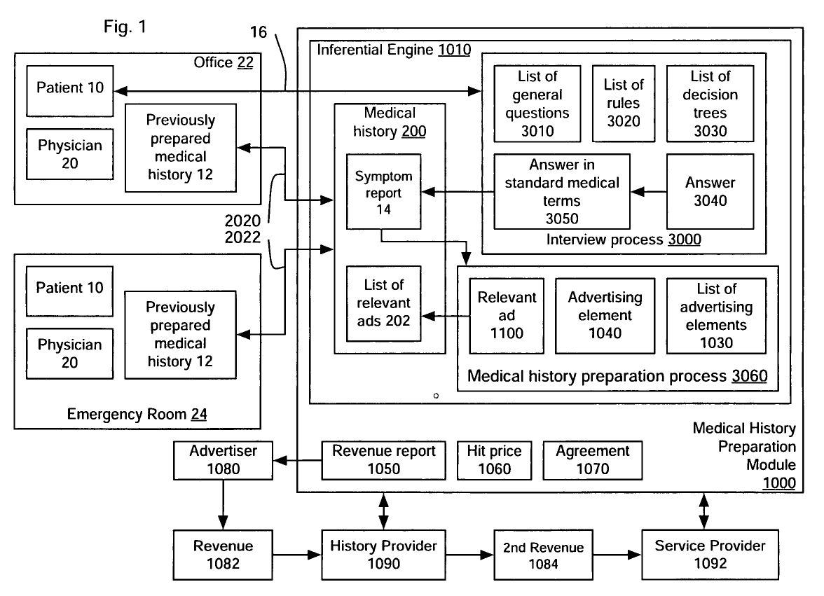

This invention aids the physician 20 and the patient 10 of FIG. 1 during a visit to an office 22 or an emergency room 24 by providing the physician with a previously prepared medical history 12 of the patient.

The previously prepared medical history 12 is based upon an interview process 3000 of FIG. 1. The interview process starts by asking a list of general questions 3010 about the health of the patient 10. Each answer 3040 to a question about the patient's health is translated into an answer in standard medical terms 3050 to create a symptom report 14 for the medical history 200.
The interview process may further ask at least one follow-on question based upon the patient's answers. The patient's answer to the follow-on question is used to refine the symptom report.
The symptom report does not attempt to diagnose the patient's health condition, but instead seeks to translate the patient's answer 3040 from into an answer in standard medical terms 3050 and to ask relevant questions based upon the answers provided by the patient and in many cases, their medical history 200. The medical history 200 grows with each patient interaction.
The symptom report 14 expedites the use of time by the physician 20 and maximizes the time that can be spent on treatment and/or education of the patient.
The symptom report 14 is a product of the interview process 3000, and has significant potential as a statistical indicator of epidemics.

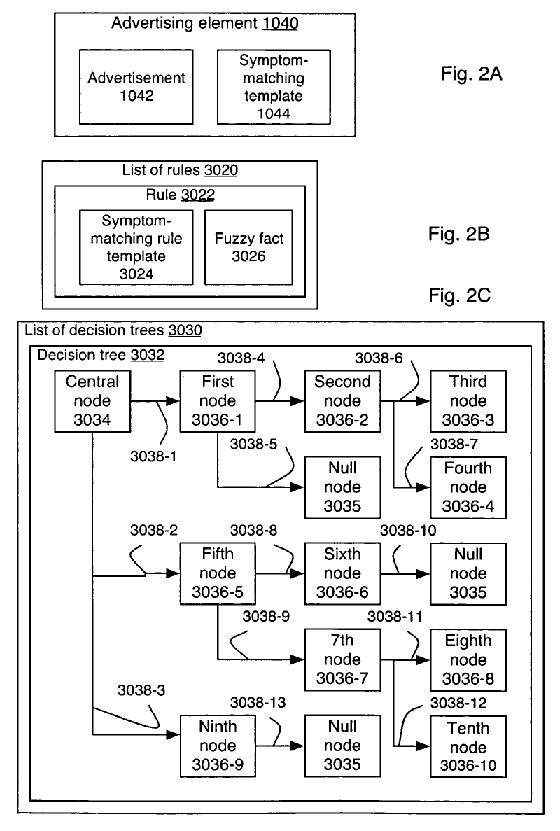

The interview process 3000 may preferably be implemented as an inferential engine 1010 including a list of rules 3020 and a list of decision trees 3030, as in FIG. 1. The Medical History Preparation Module 1000 may preferably embody the inferential engine 1010. The inferential engine may be preferably implemented by at least one computer executing a program system residing as program steps in a memory accessed by the computer. Alternatively, the inferential engine may be implemented using finite state machines, and/or Field Programmable Gate Arrays (FPGAs).
Each rule 3022 in the list of rules 3020 contains a symptom-matching rule template 3024 and a fuzzy fact 3026 as shown in FIG. 2B. By way of example, the symptom-matching rule template may trigger the fuzzy fact, that the patient may have the symptoms of one of the following: a cardiac event, or food poisoning, radiation illness, or an aneurysm.
The list of decision trees 3030 includes at least one decision tree 3032, each of which starts from a central node. By way of example, the central node may involve the patient's sex, patient's ethnicity, and/or age group, and/or drug history, and/or disease history.
Each decision tree may further include a directed list of decisions. Each decision is based upon a statement of fuzzy facts, and includes at least one directive.
The statement of the fuzzy facts may include elements of the symptom report, such as the patient's sex, ethnicity, age group, drug history, and/or disease history. The statement of the fuzzy facts may also include statistical analyses of the incidence of the fuzzy facts over a period of time and/or within the locality.
The directive may include, but is not limited to, a question to be asked of the patient, a query to a medical library database 2620, a query to a clinical trial database 2630, a pharmaceutical company 2640, a medical supplier 2650, and the Center for Disease Control 2610, a message reporting a statement of at least one fuzzy fact.
The inferential engine may further preferably adapt to the results of the visits to the office and/or emergency room to alter the list of rules and/or alter the list of decision trees.

According to another embodiment, the Medical History Preparation Module 1000 may be used on a computer personally owned and operated by the patient 10, which may lack an Internet connection.
The answer 3040 and/or the symptom report 14 may not be communicated or transmitted to the physician prior to the patient arriving at the office 22 of the physician 20.
When the patient arrives at the physician's office, the physician's assistant, who will be referred to herein as a receptionist 30 may preferably type and/or scan in the information and transmit it to the local Medical History Preparation Module 1000 server.
The Medical History Preparation Module 1000 may preferably route the symptom report 14 to the Data Centralization System 2000.
The symptom report 14 may be routed to the means for preparing the medical history 5200, which may then return the medical information and product information as the medical history to the Data Centralization System 2000 and the previously prepared medical history 12 to the physician's office 22.

Some of the following figures show flowcharts of at least one method of the invention, possessing arrows with reference numbers. These arrows will signify of flow of control and sometimes data supporting implementations including at least one program operation or program thread executing upon a computer, inferential links in an inferential engine, state transitions in a finite state machine, and dominant learned responses within a neural network.

The operation of starting a flowchart will be designated by an oval with the text “Start” in it, and refers to at least one of the following. Entering a subroutine in a macro instruction sequence in a computer. Entering into a deeper node of an inferential graph. Directing a state transition in a finite state machine, possibly while pushing a return state. And triggering a collection of neurons in a neural network.

The operation of termination in a flowchart will be designated by an oval with the text “Exit” in it, and refers to at least one or more of the following. The completion of those operations, which may result in a subroutine return, traversal of a higher node in an inferential graph, popping of a previously stored state in a finite state machine, return to dormancy of the firing neurons of the neural network.

The previously prepared medical history 12 of FIG. 1 may further preferably include a list of relevant advertisements 202 for medical products and/or services compatible with the medical history 200, as a product of a process preparing the medical history 200 based upon the symptom report and a list of advertising elements 1030, which includes at least one advertising element 1040.
Each advertising element 1040 includes an advertisement 1042 and a symptom-matching template 1044 as shown in FIG. 2A.
The symptom-matching template 1044 is compared to the symptom report 14 of FIG. 1.
Each advertising element 1040, whose symptom matching template 1044 is compatible with the symptom report 14, contributes its advertisement 1042 to the list of relevant advertisements 202 to be included in the medical history 200, which is presented as the previously prepared medical history 12.
The inferential engine 1010 may preferably adapt to the symptom-matching template 1044 of at least one advertisement 1040.

The process preparing the medical history delivers product information from pharmaceutical companies and medical suppliers to the physician 20 and the patient 10 via an ad server based on a medical history 200 of the patient 10 and the symptom report 14 at the point of care.

The method also provides a means for pharmaceutical companies and medical suppliers to advertise their products and brand at the point of care, whereas otherwise the monies are inefficiently spent on representatives, subsidized or free meals, pens and other advertising away from the point of care.

In addition, the invention includes delivery of the most up to date and relevant medical studies, disease control center news and statistics, and information on treatments and any off-label drugs. Advertising monies can preferably be used to subsidize the delivery of this information.

In addition, the invention may preferably deliver information on off-label drugs. Off-label drugs are defined as those drugs that have been approved for one indication, but not another indication, but have been shown to be effective in treating the latter indication as well. Advertising will preferably not be used subsidize this activity.

This inventions introduction of pertinent and relevant information, customized to the patient 10 in question, to a physician 20 while the patient is physically present represents a new way of delivering care.
Physicians are kept updated on all the latest treatment options at all times.
Physicians will now have suggested treatments presented to them while they are pondering possible courses of actions.
This presentation of options while physicians are in the act of providing care will also re-enforce their continuing education.
Instead of having to constantly read up on the latest medical information ahead of time and anticipating what he might be encountered in an office visit, now the newest options will be presented in real time during a relevant situation at the point of care.
Furthermore, this not only represents a huge benefit to the physician in helping to accelerate their expertise, but it also represents a huge benefit to the patient as well.
The patient will have a higher probability of their physician will be considering the latest options for their treatments for their benefit.
These benefits may include, but are not limited to, fewer side effects, quicker recovery time, low morbidity, and even life saving options that the physician previously would not have uncovered.

The invention includes a method of doing business with at least medical advertiser 1080, which generates at least one relevant advertisement 1100 of FIG. 1.
Each relevant advertisement targets the physician 20 with products and services relevant to the patient's symptoms and medical history 200.
The business method generates revenue 1082 from this targeted advertising for a medical history provider 1090.
The revenue 1082 of the medical history provider 1090 may preferably provide a second revenue 1084 to a medical service provider 1092 to maintain, distribute and provide the interview process 3000 and mechanism, as well as the medical history preparation method 3060 and mechanism.

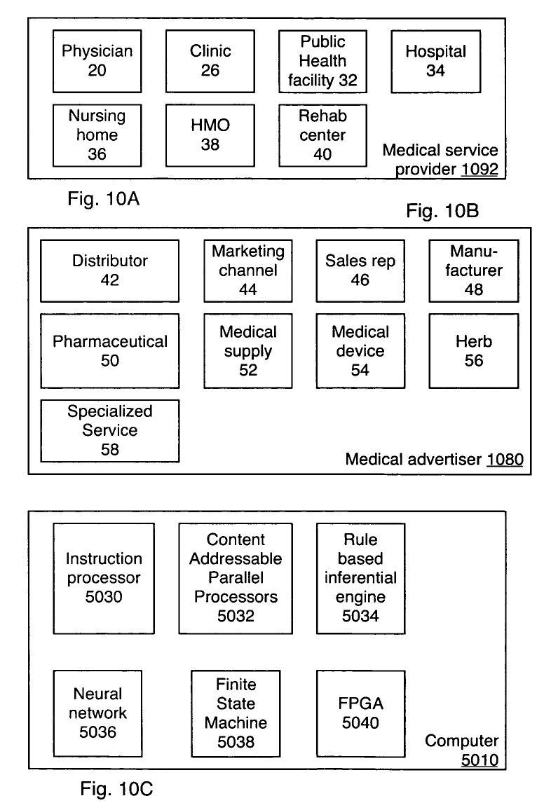

The medical service provider 1092 of FIG. 1 may be any of a physician 20, a clinic 26, a public health facility 32, a hospital 34, a nursing home 36, a Health Maintenance Organization 38 (HMO), and a rehabilitation center 40, as shown in FIG. 10A.
The medical service provider may preferably manage at least one computer executing the program system 7100 at least partly implementing the interview process 3000 and/or the program system 7200 at least partly implementing the medical history preparation process 3060 of the medical history 200.
The medical history provider 1090 preferably manages the list of advertising elements 1030.

The medical advertiser 1080 of FIGS. 1 and 10B may include a distributor 42, a marketing channel 44, a sale representative 46, and/or a manufacturer 48 of any of the following: a pharmaceutical 50, a medical supply 52, a medical device 54, an herb 56, and a specialized service 58.
By way of example, a special service 58 may include, but are not limited to, forms of physical therapy, acupuncture, mid-wives, shiatsu, massage, psychiatrists, psychological counseling, and training seminars.
A medical device 54 may include, but are not limited to, various forms of pace makers, grafting media, wheel chairs, blood substitutes, hearing aids, optical enhancements, and prosthetic aids.

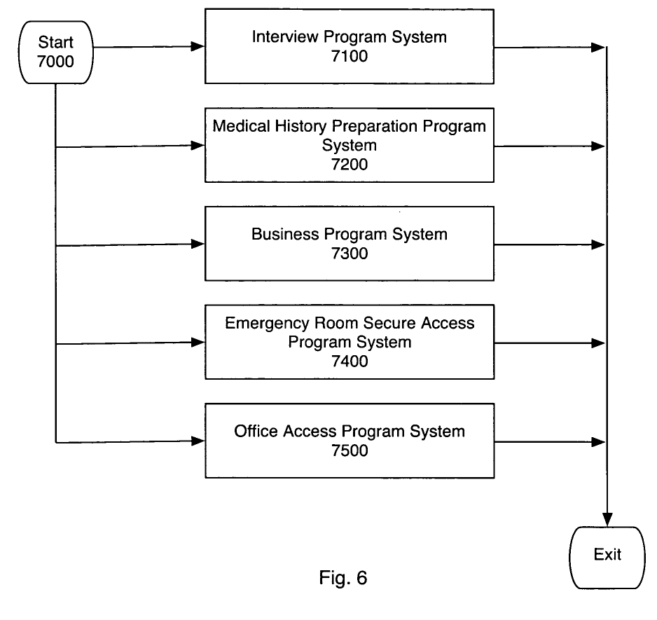

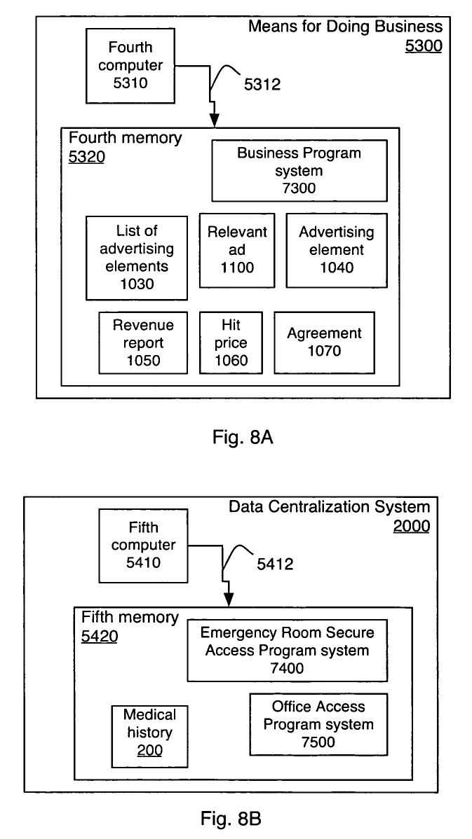

The method of doing business will be illustrated by the business program system 7300 of FIGS. 6 and 8A. The method includes the following operations:
The medical advertiser 1080 of FIGS. 1 and 10B presents the advertising element 1040 including an advertisement 1042 and a symptom-matching template 1044 to a medical history provider 1090.
An advertising hit price 1060 is established between the medical advertiser and the medical service provider to create an agreement 1070.
The agreement 1070 includes a commitment by the medical service provider to include the advertisement element 1040 in the list of advertising elements 1030, as well as, to include the advertisement 1042 in the list of relevant advertisements 202 when the symptom-matching template 1044 is compatible with the symptom report 14 of a patient 10.
When the advertisement 1042 is included in the list of relevant advertisements 202, a revenue report 1050 is altered to add the advertising hit price 1060. The medical advertiser 1080 receives the revenue report and creates the revenue 1082 received by the medical history provider 1090.
The agreement 1070, the list of advertising elements 1030, the list of relevant advertisements 202, the revenue report 1050, and the revenue 1082 are products of this business method.

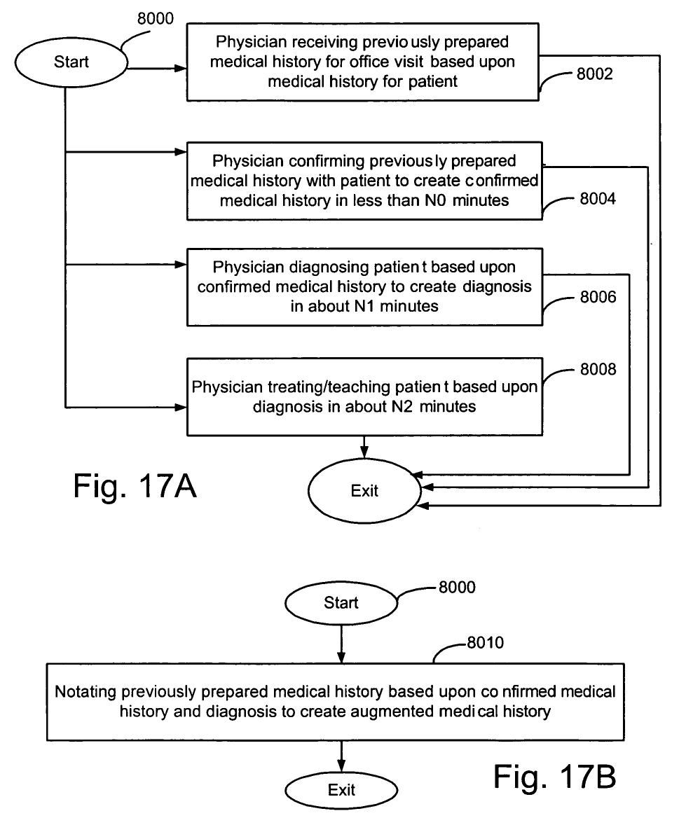

Consider a functional overview to a non-emergency, office visit. FIG. 17A is a diagram that illustrates an approach for non-emergency office visit, according to various embodiments of the invention.

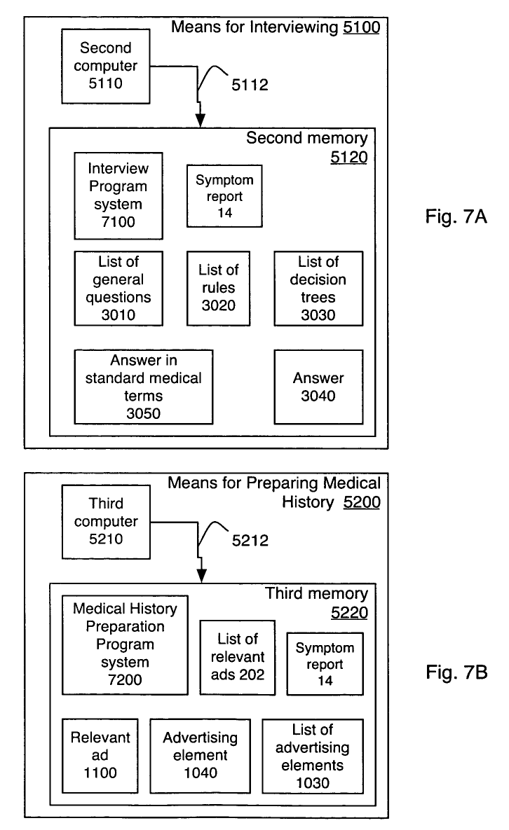

According to one embodiment, prior to the patient 10 visiting the office 22, the Medical History Preparation Module 1000 (MHPM) gathers information on a medical history 200 of the patient, current symptoms and medication, and other treatments. The Medical History Preparation Module 1000, described in greater detail in FIGS. 1, 4, 5, and 9, is often preferably a computer, such as the first computer 5010. The medical history preparation module 1000 may further include a second computer 5110 of FIG. 7A acting as an application server for the interview program system 7100. The patient may use a web browser 5630 running on a computer in the patient's home, the physician's office or any other location with a communications connection to the Internet.

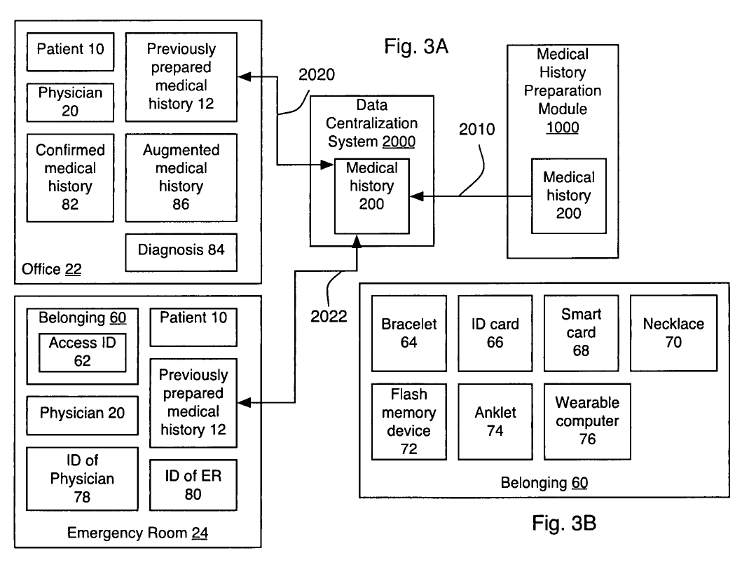

The data collected by the Medical History Preparation Module 1000 may preferably be transmitted via first link 2010 to the Data Centralization System 2000 as shown in FIG. 3A. A first link 2010 transfers data between the Medical History Preparation Module 1000 and the Data Centralization System 2000. It may be any medium used for transferring data, including the “Internet”, and/or the global packet—switched network. The Data Centralization System 2000 includes hardware and software for storage and routing which will be described in greater detail, and one embodiment of its logic is illustrated through a flow diagram in FIG. 8B.

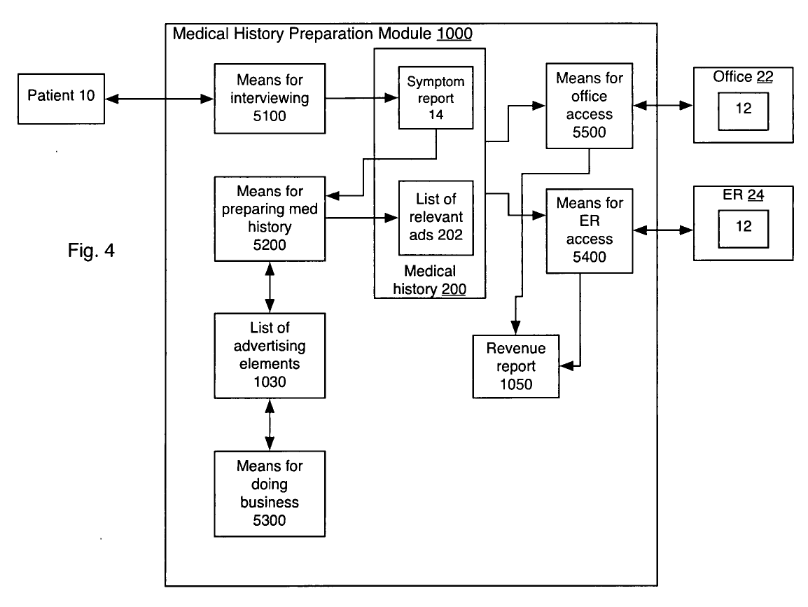

In addition, the Data Centralization System 2000 routes the information to the Point of Care Product Presentation 12, also referred to herein as the previously prepared medical history 12 via a second link 2020, as shown in FIG. 3B.
Means for preparing the medical history 5200 of FIG. 4, may include, access, and/or be an ad server for pharmaceutical products that match the specifications of the medical data in the symptom report 14, and other servers for other products and services.
The Point of Care Product Presentation 12 may return the data back to the Data Centralization System 2000 via the second link 2020.
The data centralization system 2000 may retain a copy of the medical history 200, the confirmed medical history 82, the diagnosis 84, and/or the augmented medical history 86.
The data centralization system 2000 may further return any of these products of its processes back to the Medical History Preparation Module 1000.
From the product, which now includes the patient's medical history, a summary and analysis of his condition, and relevant and possible treatments and products or services are provided to the patient 10 and the physician 20, which he has designated.
In the FIG. 3A, first link 2010 and second link 2020 are often preferably secured connections provided by one or more Internet Service Providers.

The interview process 3000 preferably uses an inferential engine 1010, further preferred, an adaptive inferential engine, which was referred to in the provisional application as a neural net.
The inferential engine includes at least one set of rules, and in certain preferred embodiments, at least one set of decision trees programmed to mimic the thought process that the physician 20 would use to gather the medical history 200 of the patient 10.
The medical history preferably includes at least one current symptom of the patient.
The inferential engine is able to gather a medical history of the patient and analyze the patient's current medical problem by a asking questions.
They may include, but are not limited to, at least one question about an area of the patient's body, symptom or set of symptoms, and the names of illnesses and/or diseases.

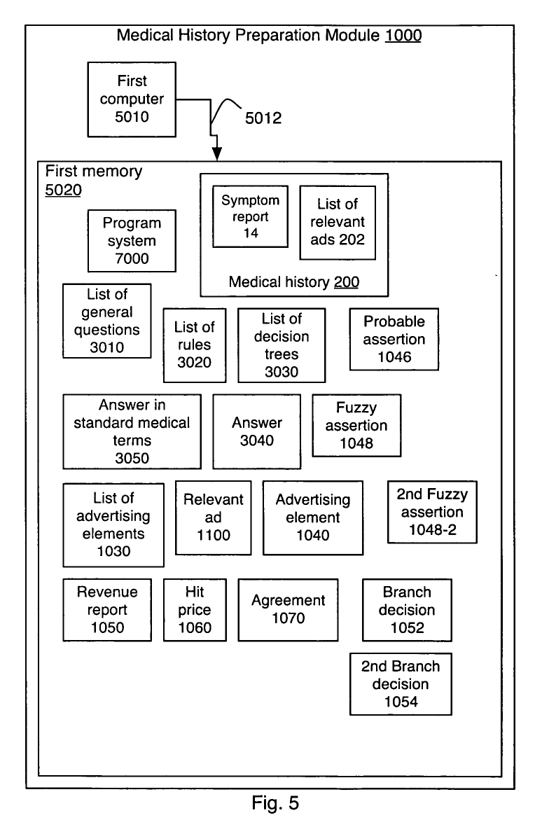

FIG. 5 shows an example embodiment of the medical history preparation module 1000 of FIGS. 1 and 4, including a first computer 5010 first accessibly coupled 5012 to a first memory 5020, which includes a program system 7000. The program system 7000 is further shown in FIG. 6 including the following.
An interview program system 7100, which at least partly implements interacting the patient 10 of FIG. 1 using the interview process 3000. The interview program system 7100 is also shown included in a second memory 5120 second accessibly coupled 5112 with a second computer 5110 in FIG. 7A.
A medical history preparation program system 7200, which at least partly implements the medical history preparation process 3060. The medical history preparation program system 7200 is also shown included in a third memory 5220 third accessibly coupled 5212 with a third computer 5210 in FIG. 7A.

A computer, for example the first computer 5010 of FIG. 5, as used herein may preferably include, but is not limited to an instruction processor 5030 as shown in FIG. 10C.
The instruction processor includes at least one instruction processing element and at least one data processing element, each data processing element controlled by at least one instruction processing element.
The data processing elements may act upon data based upon access by address or based upon content.
A computer acting upon data based upon content is sometimes referred to as a content addressable parallel processor 5032.
A computer may also include any combination of a rule based inferential engine 5034, a neural network 5036, a finite state machine 5038, and a Field Programmable Gate Array 5040.

The program system 7000 of FIG. 6 may further, in some cases, preferably include at least one of the following.
A business program system 7300 at least partly implementing a method doing business involving the agreement 1070, the hit price 1060, the revenue report 1050, the advertising element 1040, and the revenue 1082, involving the medical advertiser 1080 and the medical history provider 1090. The business program system 7400 is also shown included in a fourth memory 5320 fourth accessibly coupled 5312 with a fourth computer 5310 in FIG. 8A.
An emergency room secure access program system 7400 at least partly implements access to the medical history 200 of the patient 10 as the previously prepared medical history 12 in the emergency room 24.
An office access program system 7500 at least partly implements access to the medical history 200 of the patient 10 as the previously prepared medical history 12 in the office 22.

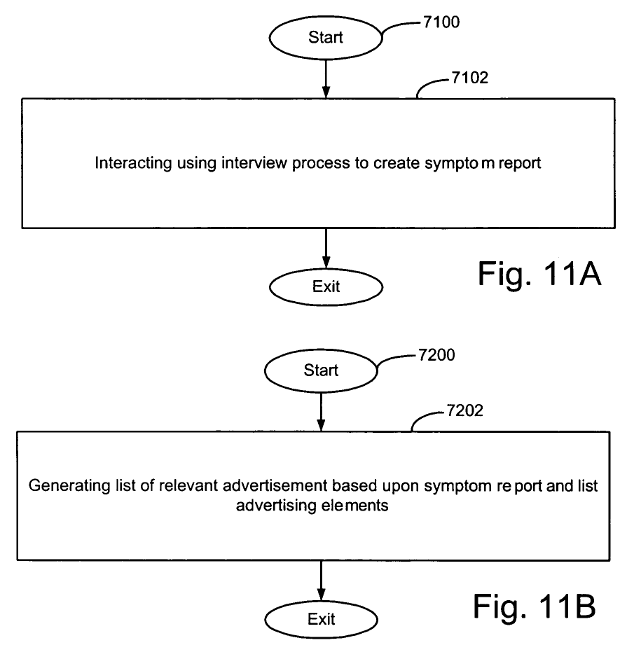

The interview program system 7100 is shown in FIG. 11A to include operation 7102 supporting interacting 16 with said patient 10 using said interview process 3000 to create said symptom report 14, as shown in FIG. 1.

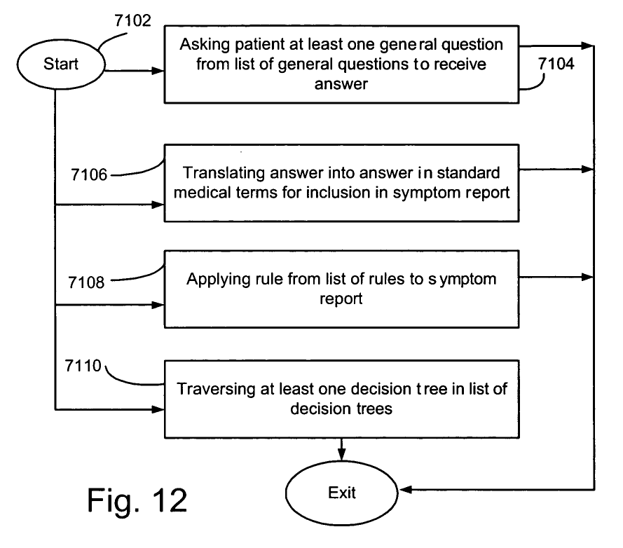

FIG. 12 shows a refinement of operation 7102, interacting with the patient, of FIG. 11A including at least one of the following operations.
Operation 7104 supports asking said patient 10 at least one general question from a list of general questions 3010 to receive said answer 3040, as shown in FIG. 1.
Operation 7106 supports translating said answer 3040 into an answer in standard medical terms 3050 for inclusion in said symptom report 14.
Operation 7108 supports applying a rule 3022, from a list of rules 3020, to said symptom report 14. Preferably, each rule 3022 includes a symptom-matching rule template 3024 and a fuzzy fact 3026, as shown in FIG. 2B.
And operation 7110 supports traversing at least one decision tree 3032 in a list of decision trees 3030.

The inferential engine 1010 may be a rule based inferential engine 5034. Specifically, it may lack the list of decision trees 3030 in favor of a sea of rules. Today, most computers access data by address rather than by content. For most computers, the list of decision trees provides significant savings in performance, and is preferred in such situations. However, the first computer 5010 may include a content addressable parallel processor 5032, which may reduce the usefulness of the list of decision trees 3030, and support a very fast rule based inferential engine 5034.

According to one embodiment, the medical history 200 of the patient 10 is gathered through a series of questions (presented in words, graphs, or both) provided by the inferential engine 1010.
The inferential engine 1010 may preferably provide a summary of the patient's medical complication as an answer 3040 translated 7106 into an answer in standard medical terms 3050.
The inferential engine may provide available treatment and medication suggestions to the patient and physician at least partly through the list of relevant advertisements 202.

According to one embodiment, through a computer with an Internet connection, the patient 10 enters his medical history 200 through a series of questions, or list of general questions 3010 provided by a inferential engine software program, known herein as the interview process 3000.

When the inferential engine 1010 has completed a summary and analysis of the patient's condition, the data is then transmitted to the Data Centralization System 2000. The Data Centralization System contacts the medical history preparation process 3060 for possible treatments as a list of relevant advertisements 202, and the patient 10 and the physician 20 may preferably be sent an electronic notice with the medical history 200 of the patient, summary and possible treatments. The patient may download the medical history for himself and the physician (or his assistant) may also preferably download the medical history as the previously prepared medical history 12.

As used herein, a decision tree 3032 includes a central node 3034 and at least one possible branch 3038 from said central node to one of a node 3036 and a null-node 3035 as shown in FIG. 2C.
A decision tree can be viewed a likely path of interviewing leading efficiently to the answers to questions which will either point out a significant disease or medical condition, or rule it out.
A node 3036, such as the ninth node 3036-9, may not have a possible branch 3038, which is shown as the possible branch 3038-13 to the null-node 3035.
A node 3036, such as the first node 3036-1, may have one possible branch 3038, which is shown as the possible branch 3038-4 to the second node 3036-2, and the possible branch 3038-5 to the null-node 3035.
A node 3036, such as the second node 3036-2, may have two possible branches 3038, which is shown as the possible branch 3038-6 to the third node 3036-3, and the possible branch 3038-7 to the fourth node 3036-4.
A node 3036, may have more than two possible branches 3038. This is shown by the central node 3034 having the possible branch 3038-1 to the first node 3036-1, the possible branch 3038-2 to the fifth node 3036-5, and the possible branch 3038-3 to the ninth node 3036-9.
Often, it is preferably to consider the decision tree 3032 as a mathematical object known as a graph. Graphs include nodes and branches connecting the nodes. Trees are specialized graphs, which do not possess circuits. A circuit is formed by starting at a first node and following its branches to another node, its branches to another node, etc. until returning to the first node without circuit visiting any other node more than once.
Preferably, the decision tree 3032 as a mathematical graph, is a tree. Preferably the list of decision trees 3030 forms a mathematical graph where if it possesses a circuit, the circuit traverses more than one decision tree.

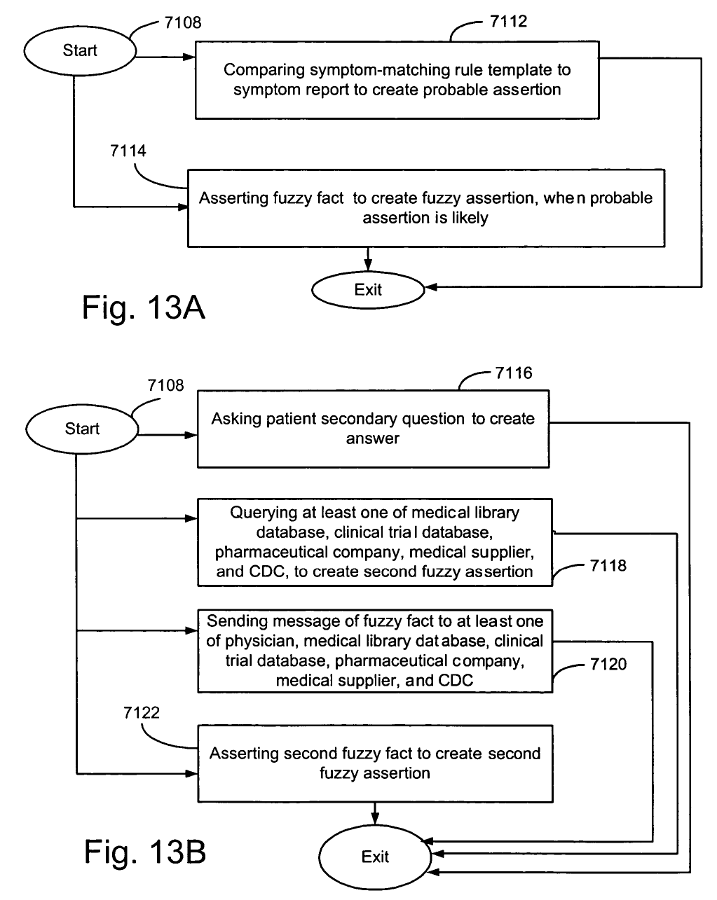

FIG. 13A shows a refinement of operation 7108, of FIG. 12, which supports applying the rule 3022 to said symptom report 14, and further includes the following:
Operation 7112, which supports comparing said symptom-matching rule template 3024 to said symptom report 14 to create a probable assertion 1046, as shown in FIG. 5.
And operation 7114, which supports asserting said fuzzy fact 3026 to create a fuzzy assertion 1048, when said probable assertion is likely.

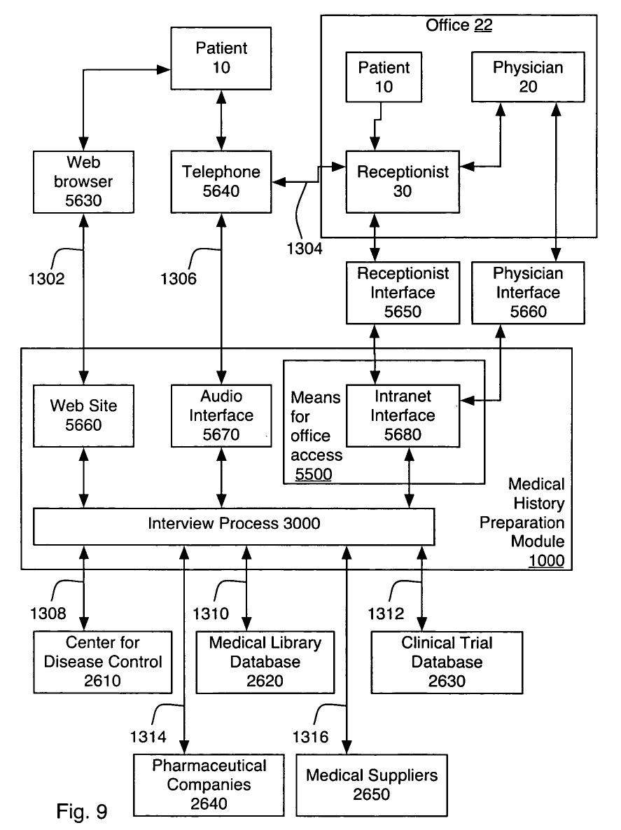

FIG. 13B shows a refinement of operation 7108, of FIG. 12, which supports applying the rule 3022 to said symptom report 14, and further includes one or more of the following:
Operation 7116, which supports asking said patient 10 of FIG. 1 a secondary question to create said answer 3040. The secondary question may preferably be included in the rule 3022, or be from the list of general questions 3010.
Operation 7118, which supports querying at least one of the medical library database 2620, of FIG. 9, a clinical trial database 2630, a pharmaceutical company 2640, a medical supplier 2650, and the Center for Disease Control 2610, to create a second fuzzy assertion 1048-2, as in FIG. 5.
Operation 7120, which supports sending a message of at least one fuzzy fact 3026 to at least one of the physician, said medical library database, said clinical trial database, said pharmaceutical company, said medical supplier, and said Center for Disease Control.
And operation 7122, which supports asserting a second fuzzy fact 3026 to create said second fuzzy assertion 1048-2.

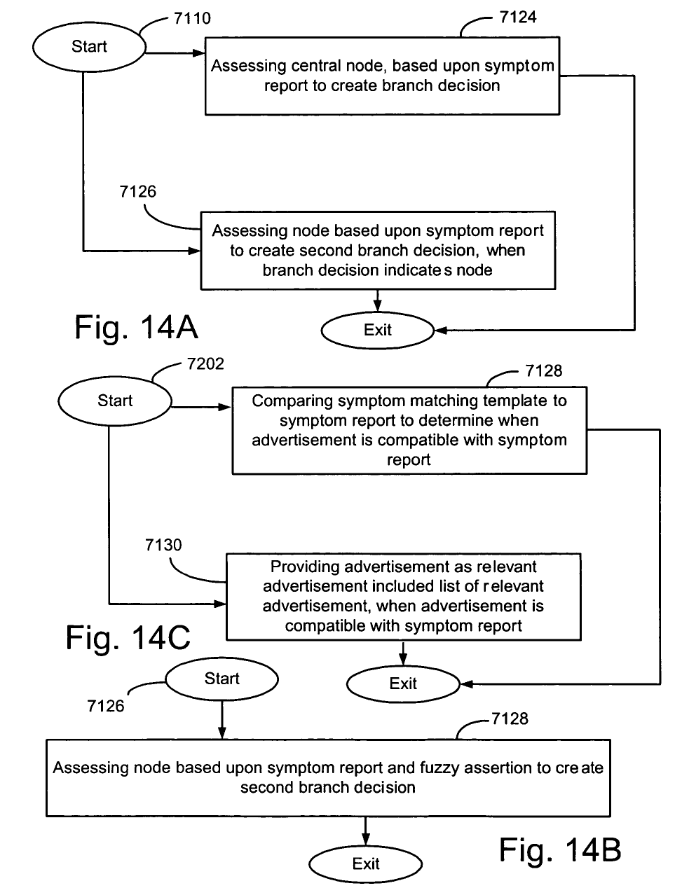

FIG. 14A shows a refinement of operation 7110, of FIG. 12, which supports traversing the decision tree 3032, and further includes the following:
Operation 7124, which supports assessing the central node 3034 of FIG. 2C, based upon said symptom report 14, of FIG. 1, to create a branch decision 1052 of FIG. 5.
And operation 7126, which supports assessing said node 3036 based upon said symptom report 14 to create a second branch decision 1054, when said branch decision indicates said node.
Note that in certain embodiments of the invention the second branch decision may be an updated version of the branch decision. In other embodiments, the branch decisions may be save on a stack or run time frame, permitting backtracking through the decision tree 3032.

FIG. 14B shows a refinement of operation 7126, of FIG. 14A, which supports assessing said node. The flowchart includes operation 7128, which supports assessing said node 3036 based upon said symptom report 14 and said fuzzy assertion 1048 to create said second branch decision.

The operation 7126, supporting assessing the node 3036, may further implement the various operations described in FIGS. 13A and 13B, previously described for applying a rule 3022.

FIG. 14C shows a refinement of operation 7202, of FIG. 11B, which supports supporting generating said list of relevant advertisements 202, and generating said list of said relevant advertisement, for at least one advertising element 1040 of said list of advertising elements 1030, further includes the following:
Operation 7204, which supports comparing said symptom-matching template 1044 of FIG. 2A to said symptom report 14 to determine when said advertisement 1042 is compatible with said symptom report.
And operation 7206, which supports providing said advertisement as a relevant advertisement 1100 included said list of relevant advertisements 202 of FIG. 1, when said advertisement is compatible with said symptom report.

One skilled in the art will recognize that advertising decision tree similar to the decision trees of the interview process could be included

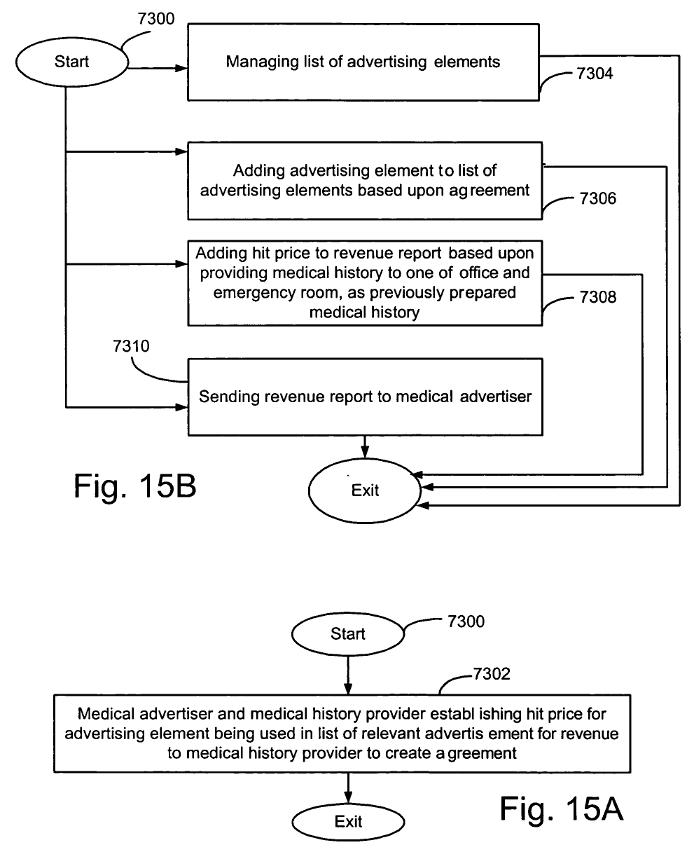

FIG. 15A shows a refinement of the business program system 7300, of FIG. 6, which supports the business method of this invention. The flowchart includes operation 7302. This supports said medical advertiser 1080 and said medical history provider 1090 of FIG. 1, establishing said hit price 1060 for an advertising element 1040 being used in the list of relevant advertisements 202 for a revenue 1082 to said medical history provider 1090, to create said agreement 1070.

FIG. 15B shows a refinement of the business program system 7300, of FIGS. 6 and 15A, and further includes the following:
Operation 7304, which supports managing said list of advertising elements 1030 of FIG. 1.
Operation 7306, which supports adding said advertising element 1040 of FIG. 2B to said list of advertising elements 1030 based upon said agreement 1070.
Operation 7308, which supports adding said hit price 1060 to said revenue report 1050 based upon providing said medical history 200 to one of an office 22 and an emergency room 24, as a previously prepared medical history 12.
And operation 7310, which supports sending said revenue report 1050 to said medical advertiser 1080.

The invention includes using the medical history 200, which includes an office access process 8000 and an emergency room secure access process 8100.
The office access process 8000 uses said medical history 200 to create a previously prepared medical history 12 for use by the physician 20 and said patient 10 in a visit to the office 22.
The emergency room secure access process 8100 uses said medical history 200 to create said previously prepared medical history 12 for use by said physician 20 attending said patient 10 a visit to the emergency room 24.

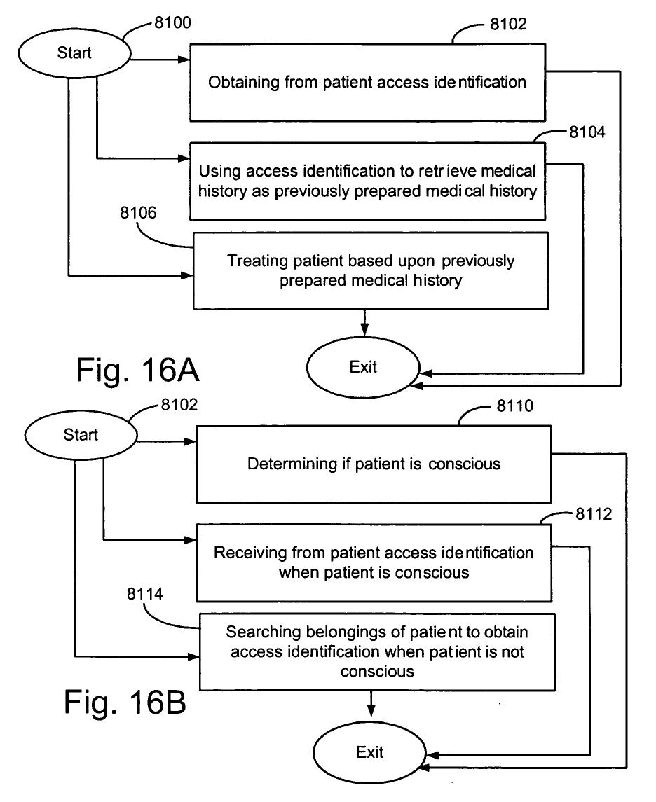

FIG. 16A shows the emergency room secure access process 8100 using said medical history 200 to create said previously prepared medical history 12 for use by said physician 20 attending said patient 10 a visit to the emergency room 24, and further including the following:
Operation 8102, supports obtaining from said patient 10 an access identification 62 as shown in FIG. 3A.
Operation 8204, supports using said access identification 62 to retrieve said medical history 200 as said previously prepared medical history 12.
Operation 8204 may further support using said access identification 62 and at least one of said physician identification 78 and an emergency room identification 80 to retrieve said medical history 200 as said previously prepared medical history 12.
And operation 8106, supports treating said patient 10 based upon said previously prepared medical history 12.

FIG. 16B shows a refinement of operation 8102, of FIG. 16A, which supports obtaining from said patient 10 the access identification 62 of FIG. 3A, and further includes the following:
Operation 8110, which supports determining if said patient is conscious.
Operation 8112, which supports receiving from the patient said access identification when said patient is conscious.
And operation 8114, which supports searching at least one belonging 60 of said patient to obtain said access identification when said patient is not conscious.
The belonging 60 may include the access identification 62 of the patient 10.

The belonging 60 of the patient 10 may include at least one of a bracelet 64, an identification card 66, a smart card 68, a necklace 70, a flash memory device 72, an anklet 74, and/or a wearable computer 76, as shown in FIG. 3B.

According to one aspect of the invention, the office access process 8000 is a method for extending the traditional physician office visit by providing for the patient's history gathering prior to the actual visit to the office 22. This method of gathering a medical history 200 of the patient 10 enables a physician 20 to allocate less time gathering the patient's medical history during the actual office visit and more time confirming the medical history, diagnosis and treatment.

The invention includes interacting 16 with the patient 10 to be able to provide and store his medical history 200 and current medical problems from any time and from any location. The recording and storage of his medical history and problems can be performed via a communications link such as the Internet, or by telephone with the help of an assistant or operator.

FIG. 17A shows the office access process 8000 including the following:
In optional operation 8002, said physician 20 receives said previously prepared medical history 12 for said office 22 visit based upon said medical history 200 for said patient 10.
In operation 8004, said physician confirms said previously prepared medical history with said patient to create a confirmed medical history 82 in less than N0 minutes.
In operation 8006, said physician diagnoses said patient based upon said confirmed medical history to create a diagnosis 84 in about N1 minutes.
And in operation 8008, said physician treats/teaches said patient based upon said diagnosis in about N2 minutes.
The sum of N0 minutes plus N1 minutes plus N2 minutes is less than Ntotal minutes.
Preferably, Ntotal is less than 20. Ntotal is further preferred less than 16.
Preferably N0 is less than 5.

FIG. 17B shows a refinement of office access process 8000, of FIG. 17A. The flowchart includes operation 8010, notating said previously prepared medical history 12 based upon said confirmed medical history 82 and said diagnosis 84 to create an augmented medical history 86.

The confirmed medical history 82 in less than N0 minutes, the diagnosis 84 resulting from the confirmed medical history, and the augmented medical history 86 are products of the use by the physician 20 of this invention.

According to another embodiment, the patient 10 may telephone a medical assistant shown as the receptionist 30 in FIG. 9.
The patient may verbally provide his medical information, sufficient for the receptionist to complete the questions provided by the inferential engine 1010 and the Medical History Preparation Module 1000.
Once the medical assistant has entered the medical information, it can be sent to the Data Centralization System 2000 and to the physician 20, as if the patient had entered the information himself.
From there, the Data Centralization System 2000 will accumulate the Point of Care Product Presentation 12 information and forward it on to the patient and the physician.

Alternatively, the patient 10 may enter the data on his computer without an Internet connection.
In such instances, the patient enters the information on his computer and the follow-up questions are provided through the interview program system 7100, which may preferably reside on a second memory 5120, which may further be a CD ROM.
The program may contains the same questions that were have been asked when the patient has an Internet or some other communications link.
The patient may save his medical information, and summary in paper or software form and present it to the physician (or his assistant), who can confirm the information, and upload the information to the Data Centralization System 2000 on behalf of the patient.
From there, the physician may receive the analysis from the Point of Care Product Presentation 12 for diagnosis and treatment of the patient.

FIGS. 3A, 4, 8B and 9 show various aspects of the invention including the means for accessing the office 22 and/or the emergency room 24.
In certain aspects, the data centralization system 2000 includes a means for office access 5500 and/or a means for emergency room access 5400.
Alternatively, the medical history preparation module 1000 may preferably include the means for office access 5500 and/or the means for emergency room access 5400.
The data centralization system 2000 is preferably communicatively coupled with said office 22 and/or communicatively coupled said emergency room 24.
The data centralization system 2000 may preferably include a fifth computer 5410 fifth accessibly coupled 5412 with a fifth memory 5420.
The fifth memory may preferably include the emergency room secure access program system 7400 and/or the office access program system 7500, previously shown in FIG. 6.

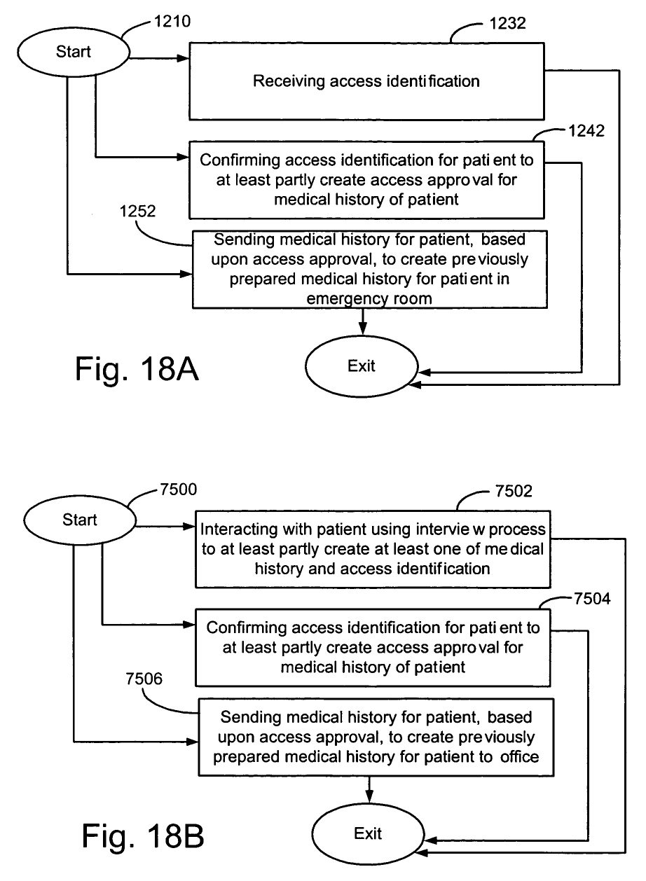

FIG. 18A shows some details of the emergency room secure access program system 7400, of FIGS. 6 and 8B, which supports said emergency room secure access process 8100 of FIGS. 16A and 16B, and further includes the following:
Operation 7402 supports receiving an access identification 62 of FIG. 3A.
Operation 7404 supports confirming said access identification for said patient to at least partly create a access approval for said medical history of said patient.
And operation 7406 supports sending said medical history for said patient, based upon said access approval, to create said previously prepared medical history for said patient in said emergency room.

FIG. 18B shows a refinement of office access program system 7500 preferably, at least partly, supports said office access process 8000 of FIGS. 17A and 17B, and further includes the following:
Operation 7502, which supports interacting with said patient using said interview process to at least partly create at least one of said medical history and an access identification.
Operation 7504, which supports confirming said access identification for said patient to at least partly create an access approval for said medical history of said patient.
And operation 7506, which supports sending said medical history for said patient, based upon said access approval, to create said previously prepared medical history for said patient to said office.

The medical history preparation program system 7200 is shown in FIG. 11B to include operation 7202 supporting generating said list of relevant advertisements 202 based upon said symptom report 14 and said list of advertising elements 1030.

One skilled in the art will recognize that data centralization system 2000 of FIGS. 3 and 8B may preferably include the emergency room secure access program system 7400 and the office access program system 7500 of FIG. 6. The means for office access 5500 of FIG. 4 may preferably include the office access program system. The means for emergency room access 5400 may preferably include the emergency room secure access program system 7400.

An example of the logic of the medical history preparation module 1000 is shown in FIG. 4, which may preferably and effectively include a Data Centralization System 2000. The data centralization system is a computer or network of computers with internal, and possibly attached or networked storage capabilities. Based upon access codes the Data Centralization System will process requests for the patient medical history 200, and additional re-route requests for treatments based upon a patient's history and current symptoms and medications. The data centralization system may route the information to the Point of Care Product Presentation 12, which will return the Point of Care Product Presentation 12's recommendations to the patient 10 to show the physician 20 and/or directly to the physician. FIG. 8B provides one possible embodiment of the Data Centralization System 2000's logic.

The medical history preparation module 1000 is preferably an apparatus including at least a first computer 5010 or network, possibly of computers with software, as shown in FIG. 4.
The medical history preparation module 1000 accepts data on a medical history 200 of the patient 10 and his current symptoms and medications, as filtered and gathered by the interview process 3000 and possibly routed via the Data Centralization System 2000 as shown in FIG. 3A.
Based on keywords and other criteria, the interview process 3000 preferably cross-references a patient's medical information and current symptoms with available pharmaceutical products via a pharmaceutical link 1314, medical supplies via a medical supply link 1316, and any available off-labeling pharmaceutical products for the illness or diseases.
In addition, the medical history preparation module 1000 may preferably be connected to the latest available medical studies via a medical library link 1310, available treatments and Center for Disease control statistics via a CDC link 1308, and clinical trials databases, if appropriate, via a clinical trial link 1312.
Each of these links may include communications via at least one wireline physical transport and/or at least one wireless physical transport and may support OSI network layer definitions supporting telecommunications, and in particular, intranets, virtual private networks, and the Internet.

In one embodiment the listing information presented as the list of relevant advertisements 202 from pharmaceutical and other companies will be returned in an order based on relevancy. In another embodiment the listing of information from pharmaceutical and other companies will be based on a combination of relevancy and advertising revenue.

The medical history preparation module 1000 preferably assembles the relevant commercially available pharmaceutical products, medical studies, treatments into the medical history 200. The medical history may then preferably be returned to a Data Centralization System 2000, where it will be stored and prepared for re-routing back to the patient 10 and physician 20, if he has been provisioned by the patient.

Consider the following functional overview of an emergency room visit. FIGS. 16A and 16B show flowcharts of an approach to patient history gathering, diagnosis, and the treatment of a patient 10 during visits to an emergency room 24. This approach is particularly useful when the patient is unconscious, or otherwise is not capable of providing his medical history 200 and background, and current symptoms and medication information.

According to one embodiment, FIG. 16A, the physician 20 (or his assistant) enters at least the access code or access identification 62 of the patient 10.
The information may be transmitted 2022, possibly by the Internet, to the data centralization system 2000.
An access identification of the physician 20 and/or of the emergency room 24 may be further required in certain embodiments.
In addition, there may or may not be other security challenges as well.
If access identification(s) are accepted, a subset of the patient's medical data may be sent via 2022, also known herein as the medical history 200 the previously prepared medical history 12.
The previously prepared medical history 12 may include, but is not limited to, the patient's blood type, allergies (if any), current medications, and other important medical information which is returned to the physician or his assistant.
The physician can use this information to in treating and stabilizing the patient.

According to another embodiment of FIG. 3A, the physician 20 (or his assistant) telephones the data centralization system 2000, also can be viewed as link 2022.
A receptionist 30 or medical specialist verifies the access code or access identification 62 of the patient 10.
A receptionist 30 or medical specialist verifies the access code or access identification of the physician and/or the emergency room, and conveys the key emergency information similar to the preceding discussion.

In the preceding description, for the purposes of explanation, specific details are set forth in order to provide a thorough understanding of the invention. However, it will be apparent that the invention may be practiced without these specific details. In other instances, well-known structures and devices are depicted in block diagram form in order to avoid unnecessarily obscuring the invention.

1. A computerized method, comprising the step of:
preparing a medical history for a patient, further comprising:
interacting with said patient using an interview process to create a symptom report; and
generating a list of at least one relevant advertisement based upon said symptom report and a list of at least two advertising elements;
wherein said medical report includes said symptom report and said list of said relevant advertisement.

2. The medical history for said patient, said symptom report, and said list of said relevant advertisement as products of the process of claim 1.

3. The computerized method of claim 1, wherein said list of said relevant advertisement includes a second of said relevant advertisements.

4. The computerized method of claim 1, wherein the step of interacting with said patient using said interview process, further comprises at least one of the steps of:
asking said patient at least one general question from a list of at least two general questions to receive said answer;
translating said answer into an answer in standard medical terms for inclusion in said symptom report;
applying a rule from a list of at least two rules, each of said rules including a symptom-matching rule template and a fuzzy fact, to said symptom report; and
traversing at least one decision tree in a list of decision trees, wherein for each of said decision trees in said list of said decision trees, said decision tree includes a central node and at least one possible branch from said central node to one of a node and a null-node.

5. The computerized method of claim 4, wherein the step applying said rule to said symptom report, further comprises the steps of:
comparing said symptom-matching rule template to said symptom report to create a probable assertion; and
asserting said fuzzy fact to create a fuzzy assertion, when said probable assertion is likely.

6. The computerized method of claim 5, wherein the step applying said rule to said symptom report, further comprises at least one of the steps of:
asking said patient a secondary of said questions to create said answer;
querying at least one of a medical library database, a clinical trial database, a pharmaceutical company, a medical supplier, and the Center for Disease Control, to create a second of said fuzzy assertions;
sending a message of at least one of said fuzzy facts to at least one of said physician, said medical library database, said clinical trial database, said pharmaceutical company, said medical supplier, and said Center for Disease Control; and
asserting a second of said fuzzy facts to create said second fuzzy assertion.

7. The computerized method of claim 5, wherein the step traversing said decision tree, further comprises the steps of:
assessing a central node, based upon said symptom report to create a branch decision, indicating one of a node, contained in said decision tree, and a null-node;
assessing said node based upon said symptom report to create a second of said branch decisions, when said branch decision indicates said node.

8. The computerized method of claim 7, wherein the step assessing said node, further comprises the step of:
assessing said node based upon said symptom report and said fuzzy assertion to create said second branch decision.

9. The computerized method of claim 7, wherein the step assessing said node, further comprises at least one of the steps of:
asking said patient a secondary of said questions to create said answer;
querying at least one of a medical library database, a clinical trial database, a pharmaceutical company, a medical supplier, and the Center for Disease Control, to create at least one of a second of said fuzzy assertions and said second branch decision;
sending a message of at least one of said fuzzy facts to at least one of said physician, said medical library database, said clinical trial database, said pharmaceutical company, said medical supplier, and said Center for Disease Control; and
asserting a second of said fuzzy facts to create said second fuzzy assertion.

10. A program system supporting the computerized method of claim 1, residing in a first memory for accessible coupling to a first computer, comprising at least one of:
an interview program system, comprising a program step of:
interacting with said patient using said interview process to create said symptom report; and
a medical history preparation program system, a program step of:
generating said list of said relevant advertisement based upon said symptom report and said list advertising elements.

11. A medical history preparation module implementing the computerized method of claim 1, comprising:
a first computer first accessibly coupled with a first memory, including a program system, including:
an interview program system, comprising a program step of:
interacting with said patient using said interview process to create said symptom report; and
a medical history preparation program system, a program step of:
generating said list of said relevant advertisement based upon said symptom report and said list advertising elements.

12. The medical history preparation module of claim 11, wherein the program step of interacting with said patient using said interview process, further comprises at least one of the program steps of:
asking said patient at least one general question from a list of at least two general questions to receive said answer;
translating said answer into an answer in standard medical terms for inclusion in said symptom report;
applying a rule from a list of at least two rules, each of said rules including a symptom-matching rule template and a fuzzy fact, to said symptom report; and
traversing at least one decision tree in a list of decision trees, wherein for each of said decision trees in said list of said decision trees, said decision tree includes a central node and at least one possible branch from said central node to one of a node and a null-node.

13. The medical history preparation module of claim 12, wherein the step applying said rule to said symptom report, further comprises the steps of:
comparing said symptom-matching rule template to said symptom report to create a probable assertion; and
asserting said fuzzy fact to create a fuzzy assertion, when said probable assertion is likely.

14. The medical history preparation module of claim 13, wherein the step applying said rule to said symptom report, further comprises at least one of the steps of:
asking said patient a secondary of said questions to create said answer;
querying at least one of a medical library database, a clinical trial database, a pharmaceutical company, a medical supplier, and the Center for Disease Control, to create a second of said fuzzy assertions;
sending a message of at least one of said fuzzy facts to at least one of said physician, said medical library database, said clinical trial database, said pharmaceutical company, said medical supplier, and said Center for Disease Control; and
asserting a second of said fuzzy facts to create said second fuzzy assertion.

15. The medical history preparation module of claim 14, wherein the step traversing said decision tree, further comprises the steps of:
assessing a central node, based upon said symptom report to create a branch decision, indicating one of a node, contained in said decision tree, and a null-node;
assessing said node based upon said symptom report to create a second of said branch decisions, when said branch decision indicates said node.

16. The medical history preparation module of claim 14, wherein the step assessing said node, further comprises the step of:
assessing said node based upon said symptom report and said fuzzy assertion to create said second branch decision.

17. The medical history preparation module of claim 14, wherein the step assessing said node, further comprises at least one of the steps of:
asking said patient a secondary of said questions to create said answer;
querying at least one of a medical library database, a clinical trial database, a pharmaceutical company, a medical supplier, and the Center for Disease Control, to create at least one of a second of said fuzzy assertions and said second branch decision;
sending a message of at least one of said fuzzy facts to at least one of said physician, said medical library database, said clinical trial database, said pharmaceutical company, said medical supplier, and said Center for Disease Control; and
asserting a second of said fuzzy facts to create said second fuzzy assertion.

18. The medical history preparation module of claim 11, wherein each of said advertising elements of said list of said advertising elements, comprises a symptom-matching template and an advertisement,
wherein the program step generating said list of said relevant advertisement, for at least one of said advertising elements of said list of advertising elements, comprises the program steps of:
comparing said symptom-matching template to said symptom report to determine when said advertisement is compatible with said symptom report; and
providing said advertisement as a relevant advertisement included said list of said relevant advertisement, when said advertisement is compatible with said symptom report.

19. The medical history preparation module of claim 11, wherein said first computer includes at least one of an instruction processor, an inferential engine, a content addressable parallel processor, a neural network, a finite state machine, and a Field Programmable Gate Array.

20. The medical history preparation module of claim 11, wherein said first memory includes a non-volatile memory component.

21. The medical history preparation module of claim 20, wherein said non-volatile memory component includes said program system.

22. The medical history preparation module of claim 21, wherein said non-volatile memory component is write protected during the operation of said program system.

23. A means for interviewing to create said symptom report of claim 1, comprising:
a second computer second accessibly coupled with a second memory, including an interview program system, comprising at least one program step of:
interacting with said patient using said interview process to create said symptom report to at least partly implement said interacting step.

24. The means for interviewing of claim 23, further comprising at least one of: a web site communicatively accessible via a web browser by said patient, an audio interface communicatively accessible via a telephone by said patient, and a means for office access by at least one of a receptionist and said physician for said patient.

25. A means for preparing said medical history of claim 1, comprising:
a third computer third accessibly coupled with a third memory, including a medical history preparation program system, comprising at least one program step of:
generating said list of said relevant advertisement based upon said symptom report and said list advertising elements to at least partly implement said step of generating.

26. The computerized method of claim 1, wherein each of said advertising elements of said list of said advertising elements, comprises a symptom-matching template and an advertisement,
wherein the step generating said list of said relevant advertisement, for at least one of said advertising elements of said list of advertising elements, comprises the steps of:
comparing said symptom matching template to said symptom report to determine when said advertisement is compatible with said symptom report; and
providing said advertisement as a relevant advertisement included said list of said relevant advertisement, when said advertisement is compatible with said symptom report.

27. The computerized method of claim 26, further comprising: a method of doing business between a medical advertiser and a medical history provider, comprising the steps of:
said medical advertiser and said medical history provider establishing said hit price for an advertising element being used in the list of relevant advertisement for a revenue to said medical history provider, to create said agreement.

28. The method for doing business of claim 27, further comprising at least one of the steps of:
managing said list of advertising elements;
adding said advertising element to said list of advertising elements based upon said agreement;
adding said hit price to said revenue report based upon providing said medical history to one of an office and an emergency room, as a previously prepared medical history; and
sending said revenue report to said medical advertiser.

29. The agreement, the revenue report, the revenue, and the advertising element to add to said list of advertising element as products of the method of doing business of claim 27.

30. The computerized method of claim 27, wherein said medical advertiser is at least one of a distributor, a marketing channel, a sale representative, and a manufacturer of at least one of: a pharmaceutical, a medical supply, a medical device, an herb, and a special service.

31. The computerized method of claim 30, wherein said special service includes, a form of physical therapy, a form of acupuncture, a form of mid-wife service, a form of shiatsu, a form of massage, a form of psychiatry, a form of psychological counseling, and a training seminar.

32. The computerized method of claim 30, wherein said medical device, includes: a form of pace maker, a form of grafting media, a form of a wheel chair, a form of a blood substitute, a form of a hearing aid, a form of an optical enhancement, and a form of a prosthetic limb.

33. The computerized method of claim 27, further comprising the step of: said medical history provider managing said list of said advertisements.

34. The computerized method of claim 27, further comprising the step of: said medical history provider sending a second revenue to a medical service provider based upon receiving said revenue.

35. The computerized method of claim 34, wherein said medical service provider is at least one of: a physician, a clinic, a public health facility, a hospital, a nursing home, a Health Maintenance Organization (HMO), and a rehabilitation center.

36. The computerized method of claim 34, wherein said medical history provider is at least one of: a physician, a clinic, a public health facility, a hospital, a nursing home, a Health Maintenance Organization (HMO), and a rehabilitation center.

37. The second revenue as a product of the process of claim 34.

38. A means for doing business implementing the method of doing business of claim 27, comprising:
a fourth computer fourth accessibly coupled to a fourth memory including a business program system at least partly implementing the method for doing business;
wherein said business program system, includes the program step of:
said medical advertiser and said medical history provider establishing said hit price for an advertising element being used in the list of relevant advertisement for a revenue to said medical history provider, to create said agreement.

39. The means for doing business of claim 38, wherein said business program system, further includes the at least one of the program steps of:
managing said list of advertising elements;
adding said advertising element to said list of advertising elements based upon said agreement;
adding said hit price to said revenue report based upon providing said medical history to one of an office and an emergency room, as a previously prepared medical history; and
sending said revenue report to said medical advertiser.

40. The method of use of the medical history of claim 1, comprising:
an office access process uses said medical history to create a previously prepared medical history for use by a physician and said patient in a visit to an office; and
an emergency room secure access process uses said medical history to create said previously prepared medical history for use by said physician attending said patient a visit to an emergency room.

41. The emergency room secure access process of claim 40, comprising the steps of:
obtaining from said patient an access identification;
using said access identification to retrieve said medical history as said previously prepared medical history; and
treating said patient based upon said previously prepared medical history.

42. The emergency room secure access process of claim 41, wherein the step of obtaining from said patient said access identification, is comprised of at least one of the steps of:
determining if said patient is conscious;
receiving from the patient said access identification when said patient is conscious; and
searching at least one belonging of said patient to obtain said access identification when said patient is not conscious;
wherein said at least one belonging includes at least one of a bracelet, an identification card, a smart card, a necklace, a flash memory device, and an anklet, including said access identification.

43. The emergency room secure access process of claim 41, wherein the step of using said access identification is further comprised of at least one of the steps of:
using said access identification and an identification of at least one of said physician and said emergency room to retrieve said medical history as said previously prepared medical history.

44. The office access process of claim 40, comprising the steps of:
said physician confirming said previously prepared medical history with said patient to create a confirmed medical history in less than N0 minutes;
said physician diagnosing said patient based upon said confirmed medical history to create a diagnosis in about N1 minutes; and
said physician treating/teaching said patient based upon said diagnosis in about N2 minutes;
wherein the sum of N0 minutes plus N1 minutes plus N2 minutes is less than Ntotal minutes.

45. The office access process of claim 44, wherein said Ntotal is less than 20.

46. The office access process of claim 45, wherein said Ntotal is less than 16.

47. The office access process of claim 45, wherein said N0 is less than 5.

48. The office access process of claim 44, further comprising the step of:
notating said previously prepared medical history based upon said confirmed medical history and said diagnosis to create an augmented medical history.

49. The augmented medical history, said confirmed medical history in less than said N0 minutes, wherein N0 is less than 5, and said diagnosis, as products of the office access process of claim 48.

50. An access system supporting the use of said medical history of claim 40, comprising:
means for office access providing said previously prepared medical history in a visit to said office; and
means for emergency room access providing said previously prepared medical history in a visit to said emergency room.

51. A data centralization system, comprising the access system of claim 50 communicatively coupled with at least one of said office and said emergency room.

52. The access system of claim 50, further comprising:
a fifth computer fifth accessibly coupled to a fifth memory, including:
an office access program system at least partly supporting said office access process; and
an emergency room secure access program system at least partly supporting said emergency room secure access process.

53. The emergency room secure access program system of claim 52, comprising the program steps of:
receiving an access identification;
confirming said access identification for said patient to at least partly create a access approval for said medical history of said patient; and
sending said medical history for said patient, based upon said access approval, to create said previously prepared medical history for said patient in said emergency room.

54. The office access program system of claim 52, comprising the program steps of:
interacting with said patient using said interview process to at least partly create at least one of said medical history and an access identification;
confirming said access identification for said patient to at least partly create an access approval for said medical history of said patient; and
sending said medical history for said patient, based upon said access approval, to create said previously prepared medical history for said patient to said office.

55. The office access program system of claim 54, wherein the program step interacting with said patient using said interview process, comprises at least one of the program steps of:
interacting via a web site with said patient using said interview process to at least partly create at least one said medical history and said access identification;
interacting via an audio interface with said patient using said interview process to at least partly create at least one said medical history and said access identification; and
interacting via a means for office access with at least one of said patient, a receptionist, and said physician, using said interview process to at least partly create at least one said medical history and said access identification.

56. The means for office access of claim 55, comprising at least one of a second of said web sites, a second of said audio interfaces, and an interface to an intranet.
